(19) United States
(12) Patent Application Publication
(10) Pub. No.: US 2008/0080565 A1
(43) Pub. Date: Apr. 3, 2008

(54) IEEE-1588 monitoring on 1000 BASE-T Ethernet technology

(76) Inventors: Martin Curran-Gray, Fife (GB); Dietrich Werner Vook, Los Altos, CA (US); Ken A. Nishimura, Fremont, CA (US); Jefferson B. Burch, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/540,036

(22) Filed: Sep. 29, 2006

(51) Int. Cl. H04J 3/06

(52) U.S. Cl. 370/503; 370/469

(57) ABSTRACT

Circuitry is included to recover the monitorable, e.g. GMII, interface into the path between the actual MAC/PHY device being used and the RJ45 connector to allow PTP circuitry to monitor the transmission and reception of the Ethernet Frames.

### BACKGROUND

To accommodate the IEEE 1588 standard for the Precision Time Protocol (PTP), it is convenient to monitor the Media Independent Interface (MII) for 10 and 100 BASE-T interfaces. The digital signals are interpreted to indicate a marker point, e.g. timestamp, for the departure and arrival of the Ethernet Frames, as they pass through the RJ45 connector.

For 1000 BASE-T interfaces, the equivalent interface is the Gigabit Media Independent Interface (GMII). The trend in silicon fabrication is to integrate the MAC and PHY functions into the same device. This has created a difficulty for 1588 implementers who want to monitor these signals in a 1000 BASE-T environment since the GMII interface is not exposed.

One proposed solution is to monitor the analog signals for 1000 BASE-T since the GMII interface is unavailable. Due to the complicated manner in which the processing is performed for analog interface on 1000 BASE-T, this is a complex task. The specification includes bidirectional operation on each of 4 differential pairs, using active cancellation to remove the contribution of the local sender to allow discrimination of the far sender's signal.

### SUMMARY

Circuitry is included to recover the monitorable GMII interface between the actual MAC/PHY device being used and the RJ45 connector to allow PTP circuitry to monitor the transmission and reception of the Ethernet Frames.

### BRIEF DESCRIPTION OF THE DRAWINGS

FIG. 1 illustrates an embodiment of the invention

### DETAILED DESCRIPTION

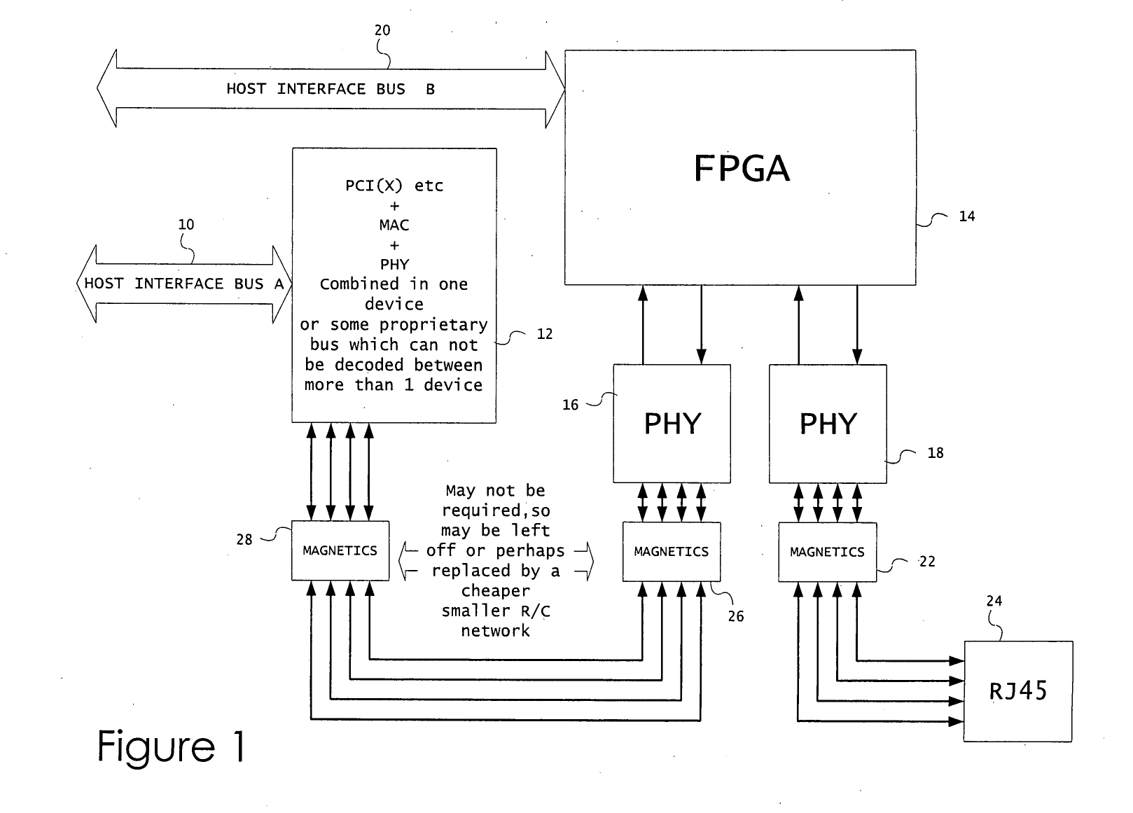

FIG. 1 illustrates an embodiment of the invention. A Host Interface Bus A 10 interacts with a device 12. The device 12 includes at least one interface, e.g. MAC/PHY, that contains data that cannot be decoded. Monitoring circuitry 14 interposes and bidirectionally communicates with a first and a second PHY 16, 18. The monitoring circuitry 14 passes extracted timing data with a Host Interface Bus B 20 which connects to a measurement sub-system (not shown). A first magnetics network 22 interposes the second PHY 18 and a connector 24, e.g. RJ45. Optional magnetics networks 26, 28 or passive R-C networks interpose the first PHY 16 and the device 12 to match the impedances between the two devices.

In this embodiment, Host Interface A is a standard computer system bus for connecting devices, i.e PCIe, while Host Interface Bus B is a collection of short BNC cables for carrying low-latency/low jitter signals such as IEEE-1588 time-stamps and time triggers, and a reference clock signal, e.g. 10 MHz.

The monitoring circuitry 14 may be implemented as a Field Programmable Gate Array (FPGA) or other suitable circuitry. It functions as a pass-thru switch. In addition, it performs the IEEE-1588 LAN packet detection and timestamping. It may contain the entire IEEE-1588 HW in some implementations. The IEEE 1588 standard may be found at the http://ieee1588.nist.gov website.

In operation, either “Host Interface Bus A” or “Host Interface B” may be used by the main processing resource of the device that requires PTP operation to be added communicates with the network hardware to have frames transmitted and received on its behalf. The Host Interface Bus A may be a PCI or PCI-X bus. In many situations, the network hardware has a combined MAC and PHY or a proprietary bus system joins them. This MAC/PHY is referred to as the “integrated PHY” in this document.

The monitoring circuitry, e.g. FPGA plus two additional PHY devices, is inserted into the path between the integrated PHY, the magnetics, and the RJ45 connector. Two single PHY devices, or alternatively a dual PHY device, are inserted into the path such that their GMII interfaces are connected “back-to-back” with the FPGA functioning as the glue logic. As the “back-to-back” GMII interfaces are connected to the FPGA, the required signals for analysis for the PTP purposes are now available.

One can incorporate the inventive concept in a variety of ways including as additional circuitry to the main circuit board of a host processor, a daughter card that plugs into the host processor via a slot, e.g. PCI or PCIe, an internal dongle, or as an external dongle. The monitoring circuitry is an adjunct to the hardware of a host processor or network. Alternatively, the interface may be MII or GMII and their respectiva derivatives thereof e.g. RMII, RGMII, SGMII etc.

We claim:

1. A system comprising:
a Host Interface Bus A;
a device includes at least one interface having network data that is only available internally;
a first and a second circuit, the first circuit receiving data from the device;
a monitoring circuit, interposing and bidirectionally communicating with the first and second circuits, extracting timing data from the device, wherein the extracted timing data is from a message-based time synchronization protocol;
a host interface bus B receiving the extracted timing data;
a first magnetics network connected to the second circuit; and
a connector connected to the second circuit.

2. A system, as in claim 1, wherein the interface is between a Media Access Control (MAC) layer and a Physical (PHY) layer.

3. A system, as in claim 2, wherein the interface is selected from a group including MII, GMII, MII derivatives, and GMII derivatives.

4. A system, as in claim 1, wherein the monitoring circuit is realized within a field programmable gate array.

5. A system, as in claim 1, further comprising at least one pair of impedance matching networks between the device and the first circuit.

6. A system, as in claim 5, the impedance matching network being a magnetics network.

7. A system, as in claim 5, the impedance matching network being a passive RC network.

8. A system, as in claim 5, wherein the connector is a RJ45 connector.

9. A system, as in claim 5, wherein the monitoring circuit includes IEEE 1588 timing analysis.

10. A system, as in claim 9, wherein the IEEE 1588 timing analysis enables the operation of the device without adversely impacting the interface.

11. A system, as in claim 1, wherein the host interface bus B exhibits low latency and low jitter.

12. A system, as in claim 1, wherein IEEE 1588 software is included in one of the device and the monitoring circuitry.
